(19) United States
(12) Patent Application Publication
(10) Pub. No.: US 2012/0016280 A1
(43) Pub. Date: Jan. 19, 2012

(54) ABDOMINAL CIRCULATORY PUMP DEVICE

(75) Inventors: Andrea ALIVERTI, Como (IT); Peter Tiffany MACKLEM, Lansdone (CA); Antonio PEDOTTI, Milan (IT); Bryan LOOMAS, Los Gatos, CA (US)

(73) Assignee: POLITECNICO DI MILANO, Milan (IT)

(21) Appl. No.: 13/240,205

(22) Filed: Sep. 22, 2011

Related U.S. Application Data
(63) Continuation of application No. PCT/IB2010/000646, filed on Mar. 23, 2010.
(60) Provisional application No. 61/210,927, filed on Mar. 23, 2009.
(60) Provisional application No. 61/215,013, filed on Apr. 30, 2009.
(60) Provisional application No. 61/280,347, filed on Nov. 2, 2009.

(51) Int. Cl. A61H 31/00

(52) U.S. Cl. 601/41

(57) ABSTRACT

The abdominal circulatory pump uses expulsive manoeuvres performed by contraction of the diaphragm while stabilizing, contracting or compressing the abdominal wall to increase abdominal pressure and pump blood. At the same time, it can be used to lower pleural pressure around the surface of the lung to provide ventilation. In humans the blood in the splanchnic circulation; i.e., the blood in the abdominal contents, is a reservoir of about 20% to 25% of the whole body blood volume. The increase in abdominal pressure forces this blood to flow out of the abdomen and through the body.

### CROSS-REFERENCE TO RELATED APPLICATIONS

This application is a continuation of PCT International Patent Application Number PCT/IB2010/000646, filed on Mar. 23, 2010 which claims benefit of priority to U.S. Provisional Patent Application Nos. 61/210,927 filed on Mar. 23, 2009; 61/215,013 filed on Apr. 30, 2009 and 61/280,347 filed on Nov. 2, 2009, the contents of which are incorporated herein by reference in its entirety.

### BACKGROUND OF THE INVENTION

The present invention relates to a device to activate the abdominal circulatory pump.

There are hundreds of thousands of cardiac arrests each year which lead to death of the patient, mostly due to poor perfusion of the brain and other tissues. There are additional hundreds of thousands of patients suffering from conditions of the heart which result in inadequate blood flow.

For cardiac arrest, there are many therapies and devices which have been attempted or are currently in use. Cardiopulmonary resuscitation via chest compressions (CPR) is a well known and valuable method of treating a patient whose heart has stopped beating (asystole or ventricular fibrillation). However it only helps to circulate blood. It does not ventilate the patient which is necessary because almost all patients with cardiac arrest stop breathing. CPR is used to resuscitate people who have suffered from cardiac arrest after heart attack, electric shock, drowning, chest injury and other causes, including respiratory arrest which can occur with the heart still beating. During cardiac arrest, the heart stops pumping blood, and a person suffering cardiac arrest will soon suffer damage to the brain and heart from lack of blood supply to these organs. Thus, CPR requires repetitive chest compressions to squeeze the heart and/or the thoracic cavity to pump blood through the body. Because the patient is usually not breathing, mouth to mouth ventilation or a bag ventilator is used to supply air to the lungs while the chest compression pumps blood through the body. It has been widely noted that CPR and chest compressions can save cardiac arrest victims, especially when applied immediately after cardiac arrest. When a first aid provider performs chest compressions well, blood flow in the body is typically about 20% of normal blood flow.

There are 500,000 in-hospital cardiac arrests which undergo attempted resuscitation annually in the United States and 700,000 total in Europe. Of those, only 18% survive to hospital discharge. There are 295,000 emergency medical services-treated out-of-hospital cardiac arrests annually in the United States, and of those, only 7.9% survive to hospital discharge. Even among survivors there is a high incidence of permanent ischemic brain damage.

Thus, many alternatives to chest compressions have been attempted in the last 30 years. These include active compression-decompression CPR, interposed abdominal compression CPR and most recently abdomen-only CPR.

There are also various machines or aids to enhance chest compressions such as the Thumper (Michigan Instruments, Inc.), the AutoPulse (ZoII Medical, Inc.), and the LUCAS (Jolife AB) for performing automated chest compressions and the ResQPOD (Advanced Circulatory Systems, Inc.) and the CPREzy Kit (Northwestern Medical LLC) for improving upon manual chest compressions.

None of these techniques or devices has proven to be a significant improvement over standard CPR. To illustrate this, a recent study published in the New England Journal of Medicine which examined trends in in-hospital survival after resuscitation stated “The rate of survival did not change substantially during the period from 1992 through 2005.” (Ehlenbach W J, et. al. Epidemiologic Study of In-Hospital Cardiopulmonary Resuscitation in the Elderly, NEJM Volume 361:22-31 Jul. 2, 2009 Number 1). Also, the American Heart Association states in their 2005 American Heart Association (AHA) guidelines for cardiopulmonary resuscitation (CPR) and emergency cardiovascular care (ECC), Part 6: CPR Techniques and Devices (Circulation 2005; 112; IV-47-IV-50) “To date no adjunct has consistently been shown to be superior to standard manual CPR for out-of-hospital basic life support, and no device other than a defibrillator has consistently improved long-term survival from out-of-hospital cardiac arrest.”

What is lacking in these solutions is adequate blood flow. None of the solutions above, including chest compressions, pumps more than 40% of the resting cardiac output. In the presence of this low flow condition, unconsciousness of the patient occurs within 15 seconds and death of brain tissue within about 10 minutes.

In addition, most current forms of CPR include positive pressure ventilation in which air is forced into the lungs by positive pressure at the nose, mouth or through a tube inserted into the trachea. This mode of ventilation increases the pleural pressure between the lungs and the chest wall and this impairs venous return and cardiac output.

Thus a recent article in The Lancet reported that “Cardiac-only resuscitation resulted in a higher proportion of patients with favourable neurological outcomes than conventional CPR in patients with apnoea (6.2% vs 3.1%; p=0.0195), with shockable rhythm (19.4% vs 11.2%, p=0.041), and with resuscitation that started within 4 min of arrest (10.1% vs 5.1%, p=0.0221). However, there was no evidence for any benefit from the addition of mouth-to-mouth ventilation in any subgroup.” Lancet, 2007, Mar. 17, pages 920-6. Positive pressure ventilation may be harmful during CPR.

Remarkably, it has been reported that an awake patient with cardiac arrest can maintain an adequate circulation to maintain consciousness by repetitive coughing. Criley J M, Blaufuss A H, Kissel G L. Cough-induced cardiac compression. Self-administered from of cardiopulmonary resuscitation. JAMA. 1976; 236:1246-1250. We believe that coughing activates the abdominal circulatory pump and that this is the mechanism which results in a circulatory output sufficient to maintain consciousness in a patient with a non-beating heart. Unfortunately the vast majority of patients with cardiac arrest are unconscious so that cough CPR is unavailable.

It would be advantageous, therefore, to provide a device which could be employed very rapidly in the in- and out-of-hospital settings for improving the treatment of cardiac arrest in an unconscious patient under emergency conditions and in other conditions where an enhanced circulatory output is desirable. Such a device should improve the circulatory output to greater than 40% of normal resting cardiac output, while providing negative pressure ventilation; i.e., lung inflation by producing negative pressure around the surface of the lung. This is the way we normally breathe and the negative pressure enhances venous return and cardiac output.

In addition to cardiac arrest, there are other conditions where enhancing blood flow might be advantageous, even in the presence of a normal heart. These include exercise hypoxia, some forms of shock, sepsis, or hemorrhage, among others.

Also, heart conditions which reduce blood flow such as congestive heart failure (CHF) may benefit from the abdominal circulatory pump device. During the last decade, CHF has burgeoned into the most important public health problem in cardiovascular medicine. As reported in Gilum, R. F., Epidemiology of Heart Failure in the US., 126 Am. Heart J. 1042 (1993), four hundred thousand (400,000) new cases of CHF are diagnosed in the United States annually. The disorder is said to affect nearly 5 million people in this country and close to 20 million people worldwide. The number of hospitalizations for CHF has increased more than three fold in the last 15 years. Unfortunately, nearly 250,000 patients die of heart failure annually.

According to the Framingham Heart Study, the 5-year mortality rate for patients with congestive heart failure was 75 percent in men and 62 percent in women (Ho, K. K., Anderson, K. M., Kannel, W. B., et al., Survival After the Onset of Congestive Heart Failure in Framingham Heart Study Subject, 88 Circulation 107 (1993)). This disorder represents the most common discharge diagnosis for patients over 65 years of age. Although, the incidence of most cardiovascular disorders has decreased over the past 10 to 20 years, the incidence and prevalence of congestive heart failure has increased at a dramatic rate. This number will increase as patients who would normally die of an acute myocardial infarction (heart attack) survive, and as the population ages. In its broadest sense, CHF can be defined as the inability of the heart to pump blood throughout the body at the rate needed to maintain adequate blood flow, and many of the normal functions of the body.

To address CHF, many types of cardiac assist devices have been developed. A cardiac or circulatory assist device is one that aids the failing heart by increasing its pumping function or by allowing it a certain amount of rest to recover its pumping function. Because congestive heart failure may be chronic or acute, different categories of heart assist devices exist. In addition to heart transplant, at least two types of chronic heart assist systems have been developed. One type employs a full or partial prosthetic connected between the heart and the aorta, one example of which is commonly referred to as a LVAD-Left Ventricular Assist Device. The LVAD operates by pumping blood at cardiac rates. Another type of chronic heart assist system is shown in U.S. Pat. No. 5,267,940 to Moulder. Moulder describes a pump implanted into the proximal descending aorta to assist in the circulation of blood through the aorta.

In addressing acute CHF, two types of heart assist devices have been used. One is counterpulsatory in nature and is exemplified by an intra-aortic balloon pump (IABP). These devices simulate a chamber of the heart and depend upon an inflatable bladder to effectuate pumping action, requiring an external pneumatic driver. A second type of acute assist device utilizes an extracorporeal pump, such as the Biomedicus centrifugal pump, to direct blood through the patient while surgery is performed on the heart. In one example, described in U.S. Pat. No. 4,968,293, the heart assist system employs a centrifugal pump in which the muscle of the patient is utilized to add pulsatility to the blood flow. The Nelson device is used to bypass a portion of the descending aorta.

Many of these heart assist systems have these features in common: the size of the blood pump, including its associated connectors and accessories, is generally unmanageable within the anatomy and physiology of the recipient, and these pumps interface with the human body by invasive means. Due to having these features, the prior art heart assist devices are limited in their effectiveness, speed of employment, and/or practicality.

It would be advantageous, therefore, to employ a heart assist system that avoids major invasive surgery. It would also be advantageous to have such a heart assist system that can be employed very rapidly in the in- and out-of-hospital settings for ease of treating acute heart problems under emergency conditions.

The present invention provides an abdominal circulatory pump according to the attached claims. We define the abdominal circulatory pump as a means to pump blood out of the splanchnic vasculature by increasing abdominal pressure thereby increasing or restarting the body's total circulatory output, so that perfusion of and oxygen delivery to other body tissues is enhanced. This invention is based on the recognition that blood in the splanchnic vasculature can be transferred to the extremities (see the article of Aliverti A, Bovio D, FuIMn I, Dellaca R L, Lo Maura A, Pedotti A, Macklem P T, “The abdominal circulatory pump”, PLoS One. 2009; Vol. 4, Issue 5.)

Assuming adequate blood flow is provided during an arrest, the chances of survival—both bodily and neurologically—should increase. It is possible to use the splanchnic vascular bed within the abdomen, which contains 20-25% of total blood volume, as a reservoir to perfuse the rest of the body. To pump blood from the reservoir, the abdominal contents need to be compressed and released in a rhythmic pattern causing intermittent increases and decreases in abdominal pressure, with little or no alteration in the pressure surrounding the lungs (pleural pressure).

The abdominal contents can be pressurized by contraction of the diaphragm at the same time as the perimeter of the abdomen is being controlled. The diaphragm can be stimulated which causes contraction. The abdominal perimeter can be controlled by stimulation or direct contact with the exterior abdominal wall. In these ways, the abdominal contents can be pressurized by the following methodologies.

Non-invasive cervical magnetic stimulation of the phrenic nerve at the cervical or thoracic spinal vertebrae, or more specifically at C7; non invasive magnetic stimulation directly over the diaphragm, or more specifically from the anterior side of the body; non-invasive magnetic stimulation at the lower thoracic and/or lumbar spinal vertebrae, or more specifically at T10; non-invasive magnetic stimulation directly over the abdominal muscles; non-invasive stimulation of the diaphragm via the phrenic nerve stimulated at the neck, or more specifically at the posterior border of the sternocleidomastoid muscle, just superior to the upper border of the clavicle; non-invasive stimulation directly adjacent to the abdominal muscles using bipolar electrodes on the skin or using bipolar electrodes via needles or other electrical conductors through the skin; manual compressions or pressure plate or belt or other wrap which can be expanded and contracted.

Combinations of the above where the different modes of abdominal pressurization and release are performed synchronously or according to specific programs aimed to optimize patient recovery. Combinations of the above through specific synchronization electrical circuits and devices.

Specific combinations of abdominal compression methods/devices include synchronous stimulation of both the diaphragm and the abdominal muscles, stimulation of the diaphragm while securing the abdomen against expansion, stimulation of the diaphragm while compressing the abdomen. Performing the combinations of abdominal compression methods above while monitoring functional outcomes such as pulse, ventilation, blood pressure, the amount of carbon dioxide (CO2) in the exhaled air, the amount of oxygen in the blood, the volume of exchanged gases, and/or other bodily functions.

Performing the combinations of abdominal compression methods above while a negative pressure threshold valve (e.g., ResQPOD Impedance Threshold) is in place on the inhalation phase of the patient's respiratory cycle.

Applying external compression of the femoral and/or brachial arteries to preferentially perfuse the brain and splanchnic bed during abdominal compressions.

Performing the combinations of abdominal compression methods above while using vasodilators to decrease vascular resistance.

Combining the methods and devices listed above with those of defibrillators such that some physical and/or electrical systems are shared. Or combining these inventions with automated external defibrillator (A ED) devices or functionalities.

### BRIEF DESCRIPTION OF THE SEVERAL VIEWS OF THE DRAWINGS

The characteristics and advantages of the present invention will be apparent from the ensuing detailed description of one embodiment thereof, illustrated by way of non-limiting example in the accompanying drawings, in which:

FIG. 1 shows schematically a placement of magnetic coils onto a patient stimulating at C7 and T10, in accordance with the present invention;

FIG. 2 shows schematically an attachment device for the placement of magnetic coils onto a patient for stimulating at C7 and T10, in accordance with the present invention;

FIG. 3 shows schematically a placement of magnetic coils onto a body stimulating the phrenic nerve, in accordance with the present invention;

FIG. 4 shows schematically a backboard with the placement of magnetic coils, in accordance with the present invention;

FIG. 5 shows schematically a backboard equipped with straps to secure the wrists or arms against unwanted motion, in accordance with the present invention;

FIG. 6 shows schematically a cross section of an abdominal binder, in accordance with a first embodiment of the present invention;

FIG. 7 shows schematically a cross section of an abdominal binder, in accordance with a second embodiment of the present invention;

FIG. 8 shows schematically a cross section of an abdominal binder, in accordance with a third embodiment of the present invention;

FIG. 9 shows schematically a cross section of an abdominal binder, in accordance with a fourth embodiment of the present invention;

FIG. 10 shows schematically a display of a device, in accordance with the present invention.

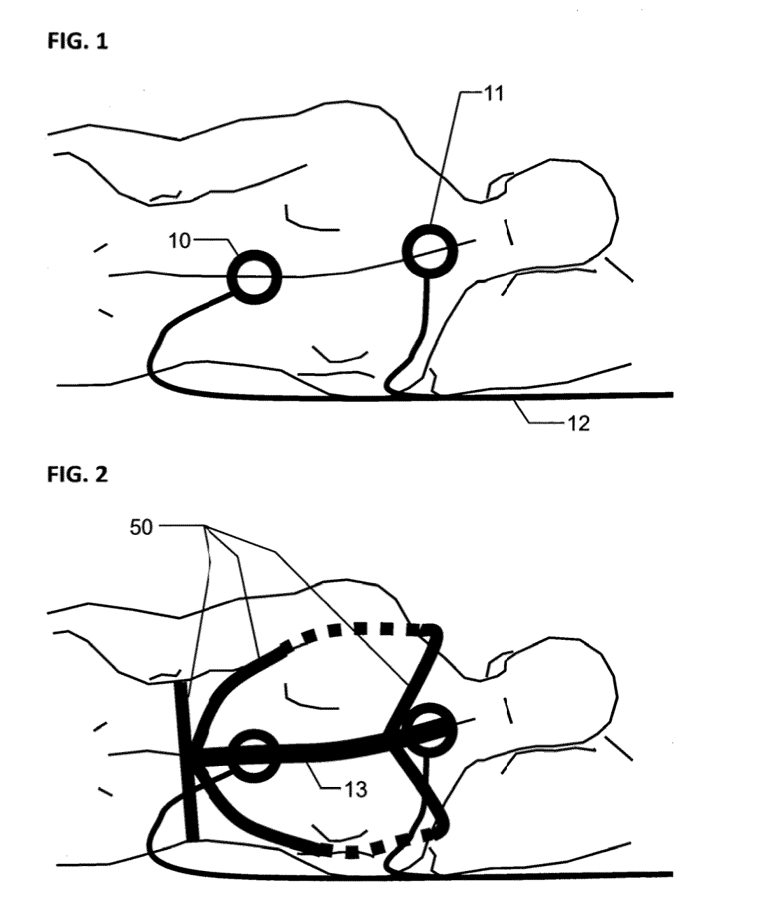

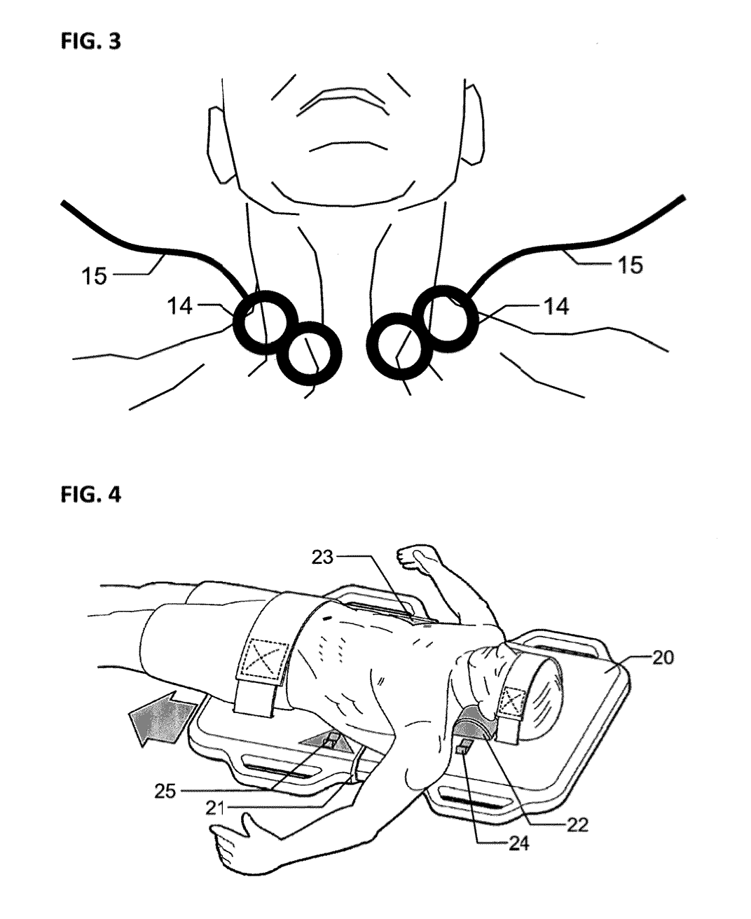

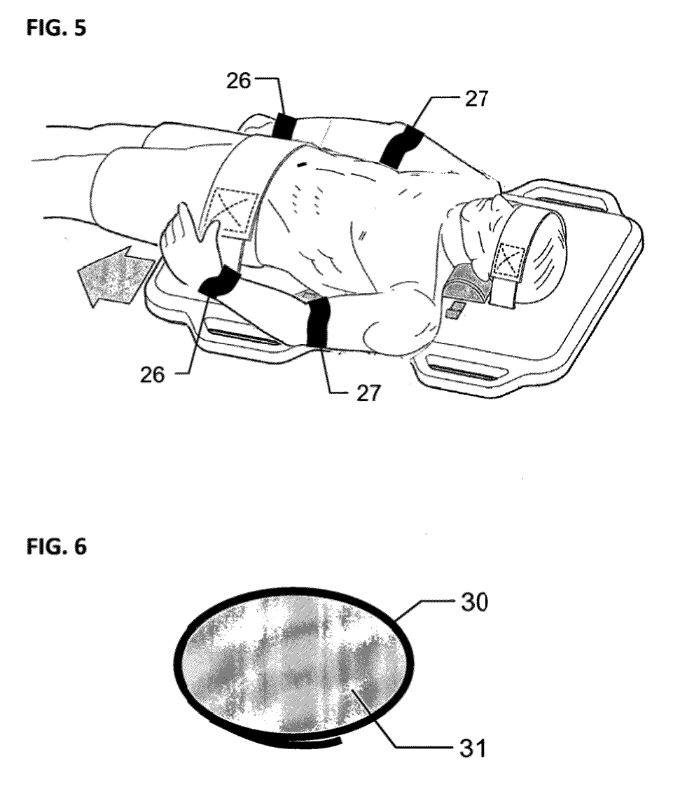

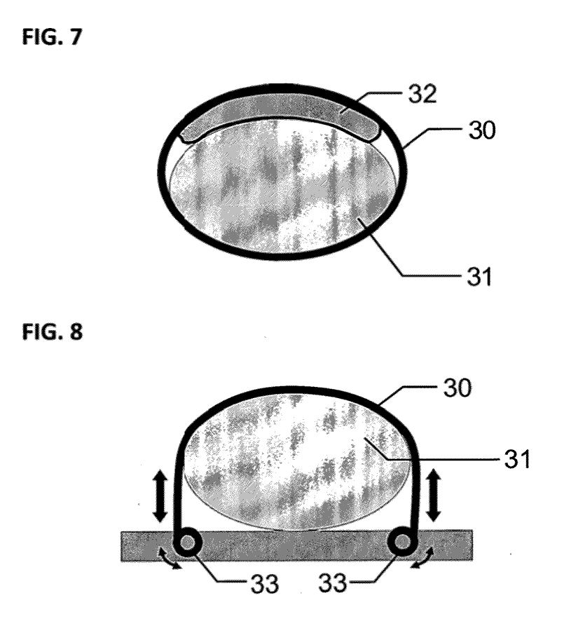

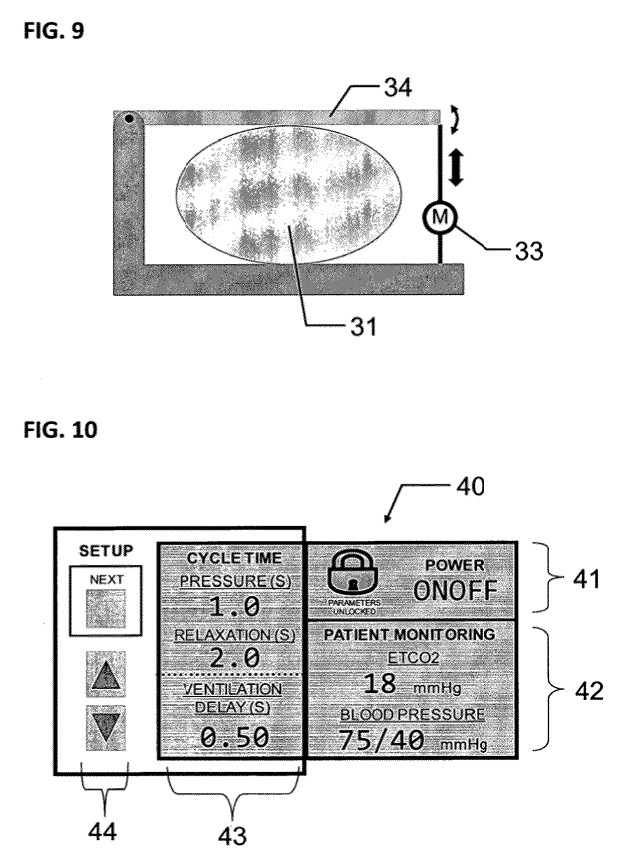

### DETAILED DESCRIPTION OF THE INVENTION

The abdominal circulatory pump uses expulsive manoeuvres performed by contraction of the diaphragm while stabilizing, contracting or compressing the abdominal wall to increase abdominal pressure and pump blood. At the same time, it can be used to lower pleural pressure around the surface of the lung to provide ventilation. In humans the blood in the splanchnic circulation; i.e., the blood in the abdominal contents, is a reservoir of about 20% to 25% of the whole body blood volume, or approximately 1.0-1.2 litres. The increase in abdominal pressure forces this blood to flow out of the abdomen and through the body. Measurements with voluntary expulsive manoeuvres in normal subjects show that it can pump between five and eight litres per minute of blood. This improvement in blood flow over other CPR or heart assist devices (a five-fold or more increase over chest compressions) is significant because brain and other tissues rapidly begin to die when not properly perfused with oxygenated blood. The contraction of the diaphragm lowers pleural pressure and ventilates the lung in the normal manner thereby avoiding the adverse effects of positive pressure ventilation on circulatory output. Expulsive manoeuvres during CPR (EM-CPR) therefore have three major advantages over all existing methods of CPR: 1) it produces a greater circulatory output; 2) it provides negative pressure ventilation which aids rather than impedes circulatory output and; 3) both ventilation and circulation result from a single intervention.

The abdominal circulatory pump uses stimulation of the diaphragm along with either external abdominal binding or stimulation of the abdominal muscles to pressurize the abdomen. Stimulation of the various muscles can be done with direct electrical stimulation (via skin contact electrodes or needles or wires inserted through the skin) or by non-invasive magnetic stimulation. Abdominal binding can be done via any external wrap or pressure plate(s) externally apposing the abdomen. This abdominal binding can either be active or passive. If active, the binding can compress and release the abdomen and if passive the binding can be applied at various levels of tightness or looseness.

Among many others, there are two variables which are independently adjustable depending on levels and/or timing of stimulation or binding: 1) abdominal pressure (Pab), and 2) pleural pressure (Ppl). Abdominal pressure will result in blood flow and a fall in pleural pressure ventilates the lung resulting in exchange of oxygen and CO2 with the blood in the lung capillaries. During normal breathing, when the diaphragm contracts Ppl falls and inflates the lung and Pab rises and displaces the abdominal wall outward. The total pressure produced by the diaphragm, trans-diaphragmatic pressure (Pdi) is abdominal pressure (the pressure on the abdominal surface of the diaphragm) minus pleural pressure (the pressure on the pleural surface of the diaphragm): Pdi=Pab−Ppl. When the abdominal muscles contract alone, Pab rises and pushes the diaphragm up into the chest. This stretches the diaphragm causing it to become tensed with a passive Pdi. Ppl nevertheless increases which deflates the lung and inhibits venous return. During EM-CPR, it is important to prevent a significant increase in Ppl. To do this the diaphragm must contract sometime during the abdominal muscle contraction or pressurization. If the increase in Pdi equals the increase in Pab, Ppl and lung volume will not change. However if the diaphragmatic contraction is just a bit greater than abdominal muscle contraction, Ppl will fall during the expulsive manoeuvre and the lungs will inflate. Experiments in normal humans show that to get an amount of blood pumped out from the splanchnic vasculature, an increase in Pab of −100 cm H2O is appropriate while a satisfactory increase in lung volume can be obtained if Ppl only falls by 3-5 cm H2O. Thus to simultaneously pump blood and ventilate the lung, the diaphragmatic contraction has to be just slightly greater than the abdominal contraction. Further, the attributes of applying the pressurization can be adjusted in order to have a) Pdi variations larger than Pab variations, b) Pdi rises preceding Pab rises, c) Pdi rises following Pab rises, or d) various combinations of the above. Additionally, the abdominal wall can move outward with each manoeuvre, but abdominal motion must be restricted in order for abdominal pressure to rise to satisfactory levels. Nevertheless for diaphragmatic contraction to ventilate the lung the abdomen must be displaced outward to some extent. As an example, if the expulsive manoeuvre is performed by diaphragmatic stimulation against a tight abdominal binder, then the binder must be loose enough so that the abdominal wall moves outward.

When ventilation is not desired by this device, tight abdominal binding or high levels of abdominal muscle stimulation can cause elevation of abdominal pressure without significant ventilation. Additionally, varying these conditions relative to one another may be desirable in different medical circumstances.

If the patient is experiencing cardiac arrest, both ventilation and blood flow which are developed by a single set of stimulation/binding parameters would be beneficial, especially if the cardiac arrest is taking place outside of a hospital setting and other equipment such as a ventilator is unavailable. In the case of heart failure in the hospital, it may be desirable to separate the inciting of blood flow (via the abdominal circulatory pump described herein) from that of ventilation (via a ventilator) so that each of these tasks is carried out by specialized equipment.

In addition to varying the amount of pressure applied by these two independent forces, the timing of the activation of these forces can also alter blood flow and ventilation. As an example, activating the diaphragm force prior to activating the abdominal force can result in ventilation followed by abdominal pressurization and blood flow. Activating abdominal muscles or abdominal compression prior to diaphragm activation would deflate the lung and lengthen the diaphragm muscle which would enable it to generate higher intraabdominal pressures to provoke an increase in blood flow while breathing in. In the same way, removing one force before the other would also provoke changes in ventilation and blood flow. For instance, removing the abdominal force prior to the diaphragmatic force might allow ventilation to occur at the end of the pressurization cycle. Timing of the start or finish of these independent forces might be combined or used separately to yield different results.

Timing between forces might vary by a fraction of a second up to a few seconds. As an example, if the cycle of 500 ms of pressurization followed by 2500 ms of relaxation is used for blood flow, the diaphragmatic contraction could begin 100 to 1000 ms prior to the abdominal force application, thus allowing ventilation to occur just prior to the start of blood flow or the diaphragmatic contraction could extend 100 to 1000 ms beyond the abdominal force application

Variations of force and timing can also be mixed and matched to elicit different responses and outcomes in ventilation and blood flow providing a large range of solutions to the differing medical conditions and phases thereof.

Where muscle stimulation is used, there is more than one position for each of the stimulators. As an example, the phrenic nerve is accessible to stimulation just posterior to the C7 vertebra, at the anterior-lateral aspect of the lower neck, or just anterior to the diaphragm, among others. Abdominal muscles can be stimulated just posterior to the T10 vertebra, for example with magnetic coil 10, or on several locations adjacent to the abdominal muscles themselves, among others.

Magnetic stimulation of the phrenic nerve is preferably achieved over either the C7 vertebra or the inferior anterior-lateral neck on both right and left sides, for example with figure-8 coils 14. The C7 vertebra is easily accessed and may be used with the dispersed magnetic field generated by a circular magnetic coil 11. The coils are connected to the electronic circuits by cables 12 and 15. One possible attachment method is a support 13 or “spine” which holds the magnets relative to each other and up against the patient, supported for example by a rigid, or a semi-rigid, or a preloaded spring or malleable support, with or without straps 50.

Another possible attachment method is to use two-sided pressure sensitive adhesive (I.e., double-sided tape) between the magnetic coils and the skin of the patient or simply to use adhesive tape over the coils to affix the coils to the skin.

Alternately, when using magnetic stimulation at the neck, a more efficient coil may be used, requiring one on each side of the neck. Additionally, there are other shapes of coils and locations which work well for magnetic stimulation of the diaphragm.

The two magnetic stimulators could be placed also onto or into a stretcher, table, bed, or backboard 20. The backboard 20 can shorten or lengthen thanks to telescopic means 21. On or in the backboard 20 are positioned the coils 22 for the phrenic nerve stimulation and the coils 23 for the abdominal stimulation. The coils 22 and 23 have the correspondent switch 24 and 25 for their activation.

The backboard 20 can be lengthened or shortened in order to place the coils correctly with respect to the person who is lying supine on it. The distance between the center of the coils can be altered for example between 30 and 60 cm.

The backboard, stretcher, table, or bed may be equipped with straps 26 and 27 to secure respectively the wrists or arms against unwanted motion caused by magnetic stimulation of their nerves near the C7 vertebra.

When using magnetic stimulation as part of the invention, parameters of the stimulations include field strength, frequency, duration, and duty cycle. By varying these parameters, it is possible to alter the characteristics of the blood flow. According to Man and colleagues (Man W D C, Moxham J, Polkey Ml. Magnetic stimulation for the measurement of respiratory and skeletal muscle function. Eur Respir J 2004; 24: 846-860), the principle of magnetic stimulation “ . . . is to cause current to flow in nervous tissue, resulting in depolarization of the nerve cell membrane and the initiation of an action potential. Magnetic stimulation creates intense, rapidly changing magnetic fields that are able to penetrate clothing, soft tissue and bone, to reach deep nervous structures. These magnetic pulses produce electrical fields, and if the induced current is of sufficient amplitude and duration such that depolarisation occurs, neural tissue will be stimulated in a similar manner to conventional electrical stimulation. Thus, the magnetic field is simply the means by which the electrical current is generated, and does not itself directly cause depolarization of cell membranes. Importantly, the magnetic fields preferentially activate larger fibres, so avoiding the smaller fibres that mediate pain.”

Field strength can vary from 0.5 to 6 Tesla, and more preferably from 2 to 4 Tesla. These values will allow non-invasive nerve depolarization and, in turn, muscle stimulation. Values higher than these are more energy consumptive and sometimes require more expensive hardware. Lower values than these may not stimulate the muscles adequately to perform the task of pumping blood.

The type or shape of the magnetic coil can affect outcomes. If a circular coil is used, it can be located less precisely so that it can be put in place quickly. FIG. 8 coils have the advantage of stimulating fewer ancillary muscles and using less power, but the disadvantage of needing to be placed and held more precisely. The more focused field of a FIG. 8 coil for phrenic nerve stimulation in the neck necessitates the use of two coils because the two phrenic nerves are too far apart for a single focused field to stimulate. Other shapes of coils can also be used with various advantages and disadvantages inherent in their designs.

Magnetic stimulation used in this application is delivered in discrete, short pulses. To effect muscle activation, several pulses may need to be given. The frequency and duration of those pulses is relevant. Frequencies range from 1 Hz to 50 Hz, and more preferably from 10 Hz to 30 Hz.

Choice of the duration of the expulsive manoeuvre via magnetic stimulation pulses or mechanical contractions in the case of an active abdominal binder will be driven by the medical application and the phase of that application. As a first example, during cardiac arrest, a duration of 200 to 3000 milliseconds (ms) of pressurization, more preferably a pressurization duration of 300 to 1500 ms, and most preferably a pressurization duration of 400 to 900 ms followed by an absence of pressurization for 500 to 5000 ms, more preferably an absence of pressurization for 1000 to 4000 ms, and most preferably, an absence of pressurization for 2100 to 3000 ms is desired.

Additionally, it may be desirable during cardiac arrest to impose a different duration of pressurization in the initial phase of device application to the patient. If no blood is circulating when the device is first applied to the patient, a longer or shorter duration of pressurization may help to instill flow in the static mass of blood throughout the circulatory system. In this case, a pressurization duration of the first pressurization, the first few pressurizations, or the first few minutes of pressurizations may be longer or shorter than those of the subsequent, ongoing pressurizations. The ratio of durations between the initial pressurizations and the ongoing pressurizations could range from 1:3 to 6:1 (“initial pressurization duration”: “ongoing pressurization duration”), or preferably from 1:1 to 3:1.

During heart assist applications, where blood is already flowing in the circulatory system, it may be desirable to pulse the stimulation in sync with the heart beat. For this application, a pulse duration of 300 to 1000 ms, more preferably a pulse duration of 500 to 700 ms followed by an absence of pulsation for the remainder of a single heart beat would be desirable. Further, an absence of pulsations could bridge multiple heart beats, for example, if a heart rate were 80 beats/minute (bpm) and a pulsation of 600 ms were applied, then an absence of pulsations could be for 150 ms to match each beat of the heart or 900 ms to provide a pulse on every second beat of the heart or 1650 ms to provide a pulse on every third beat of the heart, etc. In this way, the expulsive manoeuvres could work in sync with the heart to provide additional flow.

Further, during heart assist applications, the pulsations could be timed to coincide with systole (the contraction of the heart muscle producing peak pressures in the vasculature), diastole (the relaxing and refilling period of the heart), or any other moment throughout the phase of cardiac contraction and relaxation. These cardiac contraction phases can be sensed by monitoring electrocardiogram signals, pulse, changes in blood pressure or other means.

Various parameters discussed above can also be varied based on feedback obtained from the patient. Feedback can be obtained by monitoring of variables such as arterial oxygen saturation (SaO2) by a pulse oximeter on the finger, end tidal carbon dioxide in the expired gasses (ETCO2), blood pressure (BP) by a finger cuff, ventilatory flow rate by a flow meter attached to an endrotracheal tube or mask, blood flow velocities, or others. As an example, the forces imposed by the diaphragm and/or abdominal wall can be increased, decreased, or paused, or the duration or timing of these forces can be altered based on this feedback. As a further example, if the SaO2 increases to above 92% during a heart assist application, the device may be switched off or when the SaO2 dips below 88%, the device may be switched on.

Regarding ETCO2 monitoring, ETCO2 levels have been demonstrated in animal models to fall immediately at the onset of cardiac arrest, increase immediately with chest compressions, provide a linear correlation with cardiac output, predict successful resuscitation and allow detection of return of spontaneous circulation when a sudden increase in the ETCO2 level occurred. ETCO2 is likely to reflect the adequacy of resuscitation (higher ETCO2 value means higher cardiac output; too high ETCO2 results from inadequate ventilation.). Given this, ETCO2 levels could be used to trigger changes in the parameters of abdominal pressurizations or decreases in pleural pressure. As an example, if ETCO2 were below 10 mmHg or greater than 45 mmHg or if there were a sudden increase in ETCO2 of more than 10 mmHg resuscitation may be halted. Additionally, if ETCO2 were between 10 and 45, stimulation could be decreased proportionally to an increase in ETCO2.

Monitoring of abdominal wall motion can be obtained through sensors such as magnetometers, adhesive strain gages, mercury-in-silastic strain gages, linear variable differential transformer (LVDT), string potentiometer, optical or fiber optic sensors, or inductive plethysmography bands, or simply by palpation. One or a combination of these sensors can be placed over the skin of the subject or mounted or integrated over the internal surface of the abdominal binding in order to monitor if the final result of diaphragm and abdominal muscle stimulation is an inward or outward displacement of the abdominal wall, suggesting the presence or absence of ventilation.

Monitoring of abdominal pressure can be done while using a binder by placing a pressure transducer between the binder and the abdominal wall. Additionally, you can use a pneumotachograph or spirometer to measure ventilation.

As with ETCO2, SaO2, ventilation, abdominal wall pressure, and abdominal wall motion monitors, other feedback parameters can be used alone or in combinations to trigger changes in abdominal pressurization or ventilatory parameters of muscle stimulation or abdominal binding.

It may be desirable to reduce the abdominal pressurization parameters including magnetic field strength, magnetic frequency, or duration of the compression phase as well as force applied by abdominal binders so that less power is consumed and/or fewer non-targeted muscles are activated, or the sensation of the stimulations is reduced. Any of the aforementioned feedback mechanisms or any other feedback which informs the person who is administering the therapy that circulation is equal to or greater than needed can be used to alter parameters as well.

Abdominal binding can be achieved in several ways. As stated above, abdominal binding can be active or passive. Passive abdominal binding, carried out with an inelastic binder 30 which fastens around the abdomen 31 with hook-and-loop fastener, could be put in place at the start of use of the device and then adjusted as needed to achieve proper function of the device. Passive abdominal binders would remain at their adjusted or installed size throughout each compression/release cycle of abdominal pressurization. Active abdominal binders would move or alter their shape or size with each pressurization phase. As an example, an active abdominal binder might reduce its length during the compression phase and increase its length during the relaxation phase so that it plays a role in increasing intra-abdominal pressure during the compression phase and decreasing intra-abdominal pressure during the relaxation phase.

Abdominal binders can be actuated by various means. Motors 33, solenoids, electromagnets, and human power are examples of ways to alter the shape, size, length, or other attribute of an abdominal binder. Abdominal binders can apply force to the abdominal wall in many ways including moving plates 34, tightening straps, or pumping of air into a bladder 32 bound to the abdominal wall. The invention can further enhance survival from cardiac arrest by changing the amount of blood flow as the therapy progresses. Rea and colleagues (Rea T D, Cook A J, Hallstrom A, CPR during ischemia and reperfusion: A model for survival benefits. Resuscitation (2008) 77, 6-9) have proposed that “the benefit of the subnormal circulation produced by manual CPR is multifaceted and specifically includes attenuating reperfusion injury by providing graded blood flow to the heart and brain. Although manual CPR produces reperfusion pathophysiology, the low flow from CPR limits reperfusion injury specifically through mechanisms of post-ischemic conditioning which include attenuating peak levels of oxidative substrate and activating pathways that protect against oxidative stress. If such a hypothesis of post-ischemic conditioning is borne out, CPR may be considered a dose-sensitive therapy whereby certain physiologic states would be best served by different levels of circulation and hence distinct grades of CPR.” Blood flow imposed by this invention can be increased or decreased by altering parameters as discussed above.

It may be desirable in some applications to direct the blood flow to vital organs and/or the brain in preference to the extremities. In this case, there are many methods and devices for impeding flow to the extremities. Tourniquets, such as manual or automatic (automatically adjusting for limb occlusion pressure as an example) tourniquets, may be used to reduce or eliminate flow to the extremities where required. Military anti-shock trousers (i.e., MAST trousers) otherwise known as Pneumatic Anti-Shock Garments (PASG) or Non-pneumatic Anti-Shock Garment (NASG), may also be used.

Accessories such as instructions for use of the device, batteries, power cords, cannulae for assessing ETCO2, devices for assessing SaO2, blood pressure, ventilation, or blood flow velocities can be built into the abdominal circulatory pump or can be attached as either disposable or reusable components.

In addition to those listed above, defibrillators or automated external defibrillators may be accessories or may be integrated into the abdominal circulatory pump.

Abdominal Circulatory Pump devices can be used by physicians, emergency medical staff, or lay people. They can be applied in many settings including both inside and outside of hospitals. Further, they can be made portable and used at the scene of a cardiac arrest, during transport to a hospital, in an emergency room, or anywhere else. These devices could be applied to the patient when signs of low or no blood flow are observed. These signs might include unconsciousness, cessation of normal breathing, absence of a clearly discernable pulse or blood pressure, or electrocardiographic evidence of asystole or ventricular fibrillation. Some of these devices could also be temporarily halted during tests of heart rhythm, defibrillation, insertion of an advanced airway such as an endotracheal tube, or other purposes.

Various configurations of the devices are possible. In most variations, the device will be maintained in apposition to the patient's skin or clothing. This may be accomplished by fastening straps; removing material to expose adhesive which has been pre-applied to part of the device and then applying the adhesive to the patient's clothes or preferably skin; laying the patient on top of the device; or other means. Devices for monitoring patient attributes will be installed and maintained in various ways.

Where there are two stimulators or an abdominal binder and a stimulator mounted to the same platform, it may be necessary to adjust the distance between them to accommodate various body sizes. As an example, if the particular device contains two magnetic stimulators for use on the C7 and T10 vertebrae, a taller person will have a greater distance between these two vertebrae than a shorter person. In this case, an adjustment in the distance between the two stimulators would be made to fit the particular subject being treated. In some instances where magnetic stimulation of the diaphragm is being used, there may be collapse of the patient's upper airway as shown by Verin (Verin E, Similowski T, Teixeira A, Series F. Discriminative power of phrenic twitch-induced dynamic response for diagnosis of sleep apnea during wakefulness. J Appl Physiol 94: 31-37, 2003). In this case, and possibly in all cases, a device to stabilize the airway may be applied to the patient. These devices include endotracheal tubes, laryngeal mask airways, Esophageal-Tracheal Combitube, the King Laryngeal tube and other devices. When a defibrillator is used in combination with the abdominal circulatory pump, the feedback derived from electrocardiographic monitoring may be used for decisions regarding time to defibrillate or parameters of abdominal pressurization.

The abdominal circulatory pump may include various types of user feedback. There may be any number of controls for the user as well. One embodiment would have one control (on/off) and no feedback, other embodiments might use singly or in combination, the following feedback or controls: a configurable display 40 (such as a liquid crystal display (LCD), a thin film transistor liquid crystal display (TFT-LCD), or an electronic paper display) screen to provide various feedback (factory set or user adjustable) to the user; various status lights (e.g., on, off, blinking, or colored); switches, sliders, or knobs of various kinds; or audible feedback using voice or tone signals. The display 40 can shows the status 41 of the device and the patient monitoring information 42, a set of adjustable parameters 43 with the commands 44 for the parameter adjustment. The abdominal circulatory pump may be grouped with additional devices or accessories including batteries, cords, cannulae, oxygen saturation probes, finger cuffs for blood pressure, CO2 meters, defibrillators, automated external defibrillators, instructions for use, cleaning instructions, or others.

We claim:

1. An abdominal circulatory pump device comprising:
a diaphragmatic muscle stimulator; and
an abdominal restraint device configured to restrain a perimeter of the abdominal cavity during stimulation of a diaphragm allowing for controlling of pressure within the abdomen; and
a controller for controlling the a diaphragmatic muscle stimulator and the abdominal restraint mechanism.

2. The device of claim 1, where the diaphragmatic muscle stimulator comprises a stimulator selected from the group consisting of a magnetic coil, an electrode, and an electrical conductor.

3. The device of claim 1 where the magnetic coils comprise circular magnetic coils or figure-8 magnetic coils.

4. The device of claim 1 where the diaphragmatic muscle stimulator comprises one or more diaphragmatic muscle stimulators affixed to a frame.

5. The device of claim 4 where the frame is configured to be adjustable such that the diaphragmatic muscle stimulators can be repositioned.

6. The device of claim 4, where the frame comprises a structure selected from a stretcher, table, bed, and backboard.

7. The device of claim 1, where the abdominal restraint device comprises an abdominal muscle stimulator.

8. The device of claim 7, where the abdominal muscle stimulator comprises a stimulator selected from the group consisting of a magnetic coil, an electrode, and an electrical conductor.

9. The device of claim 7 where the abdominal muscle stimulator comprises one or more abdominal muscle stimulators affixed to a frame.

10. The device of claim 9 where the frame comprises a structure selected from a stretcher, table, bed, and backboard.

11. The device of claim 1, where the abdominal restraint device comprises an abdominal binding configured to restrict motion of the perimeter of the abdomen.

12. The device of claim 11, where the abdominal binding comprises an inelastic binder.

13. The device of claim 11, where the inelastic binder is configured to be adjustable by a motor.

14. The device of claim 1, where the abdominal restraint device comprises an inflatable device which is adjustable in pressure.

15. A method for circulating blood within a body, the method comprising:
pressurizing an abdomen by stimulating a diaphragm;
controlling a perimeter of the abdomen to restore blood flow within the body; and
depressurizing the abdomen and subsequently repeating pressurizing the abdomen while controlling the perimeter of the abdomen to maintain blood flow within the body.

16. The method of claim 15, where pressurizing and depressurizing the abdomen occurs in a rhythmic pattern.

17. The method of claim 15, where the duration of pressurization is between 400 and 900 ms.

18. The method of claim 15, where the duration of depressurizing is between 2100 and 5000 ms.

19. The method of claim 18, where stimulating the diaphragm begins prior to controlling the perimeter of the abdomen.

20. The method of claim 15, where stimulating the diaphragm extends in time beyond the controlling the perimeter of the abdomen.

21. The method of claim 15, where stimulating the diaphragm occurs using non-invasive magnetic stimulation

22. The method of claim 15, where stimulating the diaphragm comprises applying the stimulation at vertebra C7.

23. The method of claim 15, where stimulating the diaphragm comprises applying the stimulation at the posterior border of the sternocleidomastoid muscle, just superior to the upper border of the clavicle

24. The method of claim 15, where controlling the perimeter of the abdomen comprises stimulating abdominal muscles.

25. The method of claim 24, where stimulating the abdominal muscles comprises applying the stimulation at vertebra T10.

26. The method of claim 15, where controlling the perimeter of the abdomen comprises applying an abdominal binder to the abdomen.

27. The method of claim 15, where stimulating the diaphragm comprises applying the stimulation from backboard, stretcher, table, or bed.

28. The method of claim 15, where depressurizing the abdomen and subsequently repeating pressurizing the abdomen while controlling the perimeter of the abdomen to maintain blood flow within the body also results in ventilating a lung within the body.

29. A method of resuming or enhancing blood flow comprising the steps of
apposing the abdominal circulatory pump device to a patient
securing the arms against unwanted movement,
turning the device on,
observing bodily functions of the patient, and
removing the device when no longer needed.

30. A method of treating sudden cardiac arrest comprising the steps of
apposing the abdominal circulatory pump device to a patient;
turning the device on,
observing bodily functions of the patient,
adjusting the device parameters if necessary to assure adequate ventilation and blood flow, and
removing the device when no longer needed.

31. An abdominal circulatory pump device comprising:
a diaphragmatic muscle stimulator comprising at least a first magnetic coil; and
an abdominal restraint stimulator comprising at least a second magnetic coil and configured to restrain a perimeter of the abdominal cavity during stimulation of a diaphragm allowing for controlling of pressure within the abdomen; and
a frame holding the first magnetic coil and the second magnetic coil, such that when a patient is adjacent to the frame the first magnetic coil is adjacent to a C7 vertebra and the second magnetic coil is adjacent to a T10 vertebra.
